(19) United States
(12) Patent Application Publication
(10) Pub. No.: US 2020/0329636 A1
(43) Pub. Date: Oct. 22, 2020

(54) GARDEN TRIMMER EDGER ATTACHMENT

(71) Applicant: MICHAEL TING-KAO CHANG, HUNTSVILLE, AL (US)

(72) Inventor: MICHAEL TING-KAO CHANG, HUNTSVILLE, AL (US)

(21) Appl. No.: 16/913,021

(22) Filed: Jun. 26, 2020

Related U.S. Application Data
(63) Continuation-in-part of application No. 16/141,514, filed on Sep. 25, 2018, now Pat. No. 10,709,062.

(51) Int. Cl. A01D 34/73; A01D 34/84; A01D 34/00; A01D 34/416

(52) U.S. Cl. CPC A01D 34/733; A01D 34/84; A01D 34/90; A01D 34/4166; A01D 34/005

(57) ABSTRACT

The device herein is an attachment means that may be reversibly coupled to a standard, commercially-available gas or electric weed trimmer. The device includes an embodiment that couples an edger blade with multiple strings of trimmer line so that the weed trimmer is able to cut large diameter weeds and brush. Additionally, this attachment converts the weed trimmer into an edger device. An alternate attachment is formed so that a rake is coupled to the weed trimmer, allowing a user to rake weeds or soil with the weed trimmer.

### CROSS-REFERENCE TO RELATED APPLICATIONS

This application is a continuation-in-part of U.S. Non-Provisional application Ser. No. 16/141,514, and this application claims the benefit of U.S. Non-Provisional application Ser. No. 16/141,514, filed on Sep. 25, 2018, which names Michael Ting-Kao Chang as the inventor.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR JOINT INVENTOR

The inventor did not disclose the invention herein prior to the 12 month period preceding the filing of this non-provisional continuation-in-part application.

### BACKGROUND OF THE INVENTION

### (1) Field of the Invention

This invention relates to handheld weed and grass trimmer attachments that allow a weed trimmer to be modified so that it includes an edger and trimmer function in addition to a rake function.

### (2) Description of Related Art

A number of weed and grass trimmer attachment devices are shown in the prior art. None of these include a line trimmer and an edger in the same attachment. Jones (U.S. Pat. No. 10,349,576 B1) discloses a cutting and mulching device that is coupled to a lawnmower. The device of Jones comprises a number of cutter cords that circulate cutting and mulching vegetation. The cutter cords arranged so that the longest cord is positioned at the highest point above the ground, and other cutter cords positioned so that they taper to the shortest cutter cord. This device is not compatible with the device herein because the device of Jones is designed to moved forward and backward, while the device herein is designed to be moved from side-to-side.

Grant et al. (U.S. Pat. No. 6,842,984 B1) discloses a spooless trimmer head the reversibly couples to a weed trimmer The device of Grant et al. utilizes nailhead trimmer line that is inserted into an open trimmer head housing. The device of Chang herein may utilize the nailhead trimmer line of Grant et al. The device of Grant et al. does not disclose any edging means or raking means.

An improved attachment that will allow a user to both trim weeds and edge without the need for switching between attachments will make these work tasks easier and quicker. An attachment means that will allow a user to rake or till the upper layers of soil will make it easier for a user to maintain a garden or vegetable area, and improve the appearance of a garden area.

### BRIEF DESCRIPTION OF THE SEVERAL VIEWS OF THE DRAWINGS

The Garden Trimmer Edger Attachment is disclosed in FIGS. 1 through 8.

FIG. 1 depicts an angled side view of a standard gas or electric powered grass trimmer

FIG. 2 depicts an exploded view the Garden Trimmer Edger Attachment installed upon the head of a standard gas or electric powered grass trimmer

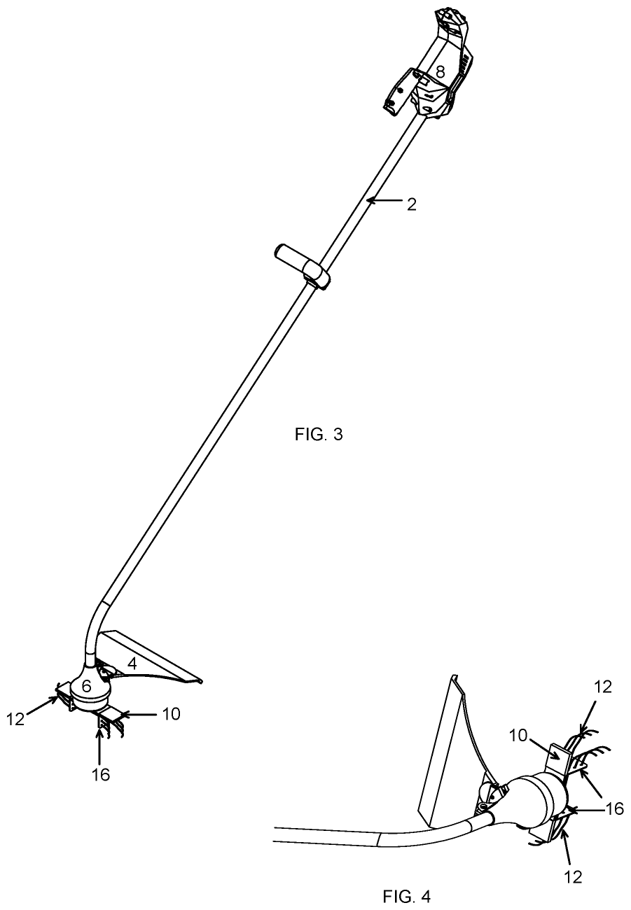

A full, side view of the Garden Trimmer Edger Attachment installed upon a standard gas or electric powered grass trimmer is shown in FIG. 3.

A side view showing the edger function being utilized is shown in FIG. 4.

FIG. 5 depicts a top, angled view of the edger bar of the device herein.

FIG. 6 illustrates a front, angled view of the trimmer head with trimmer string attached.

A front, angled view of the rake head attachment means is illustrated in FIG. 7.

FIG. 8 shows the device of FIG. 7 coupled to a standard gas or electric powered grass trimmer

### DETAILED DESCRIPTION OF THE INVENTION

This application is a continuation-in-part of U.S. Non-Provisional application Ser. No. 16/141,514. U.S. Non-Provisional application Ser. No. 16/141,514 is incorporated herein by reference as if fully set forth herein.

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, etc., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an, embodiment in the present disclosure can be, but not necessarily are, references to the same embodiment; and, such references mean at least one of the embodiments.

Reference in this specification to “one embodiment’ or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

This disclosure includes an attachment head that may be reversibly coupled to a standard, commercially-available gas or electric powered grass trimmer It comprises an edger means coupled to a trimmer means that both edges and trims in the garden. Additionally, an alternate embodiment comprises a rake means that may be reversibly coupled to the trimmer that allows a user to break up garden soil.

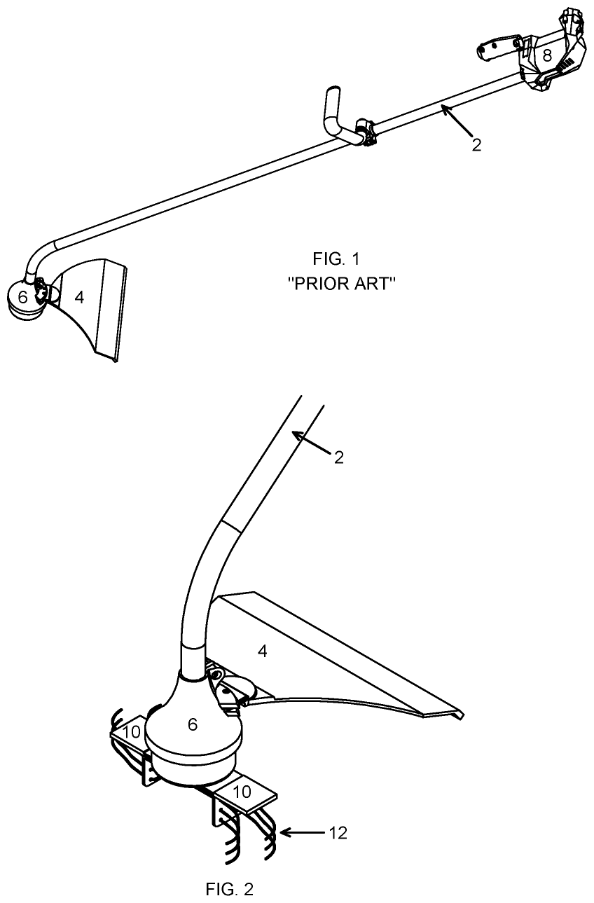

FIG. 1 depicts a standard grass trimmer The device herein may be coupled to any standard, commercially-available gas or electric powered trimmer Motor 8 may be powered by gas or a battery. Handle 2 couples motor 8 to trimmer head 6. The device herein may be reversibly coupled to trimmer head 6. Guard 4 protects a user during operation of the attachment device.

The edger embodiment of the attachment device herein is shown coupled to trimmer head 6. Handle 2 couples the attachment device to motor 8, which provides the necessary power to operate the attachment device. Guard 4 protects a user from contact with the attachment device during use. Edger blade 10 may be composed of steel, aluminum, iron, or any material strong enough to allow edger blade 10 to edge or cut a small gap between grass and the area you are trying to neatly separate from the grass. Edger blade 10 should be composed of a material that is resistant to rust, and wear and tear. Edger blade 10 rotates relative to trimmer head 6 when powered on. The rotation of edger blade 10 provides the cutting force necessary to allow a user to edge grass, turf, or other gardening materials. Trimmer line 12 may be coupled to edger blade 10 so that the movement of trimmer line 12 is coupled to the movement of edger blade 10 and moves relative to trimmer head 6 when the gas or electric gas trimmer is powered “on”.

FIG. 3 depicts the attachment device held in an upright manner so that edger blade 10 and trimmer line 12 are horizontal to the ground, while FIG. 4 depicts the attachment device positioned at an angle with the ground so that edger blade 10 is vertical relative to the ground. Edger blade 10 may comprise a sharp edge upon its outer perimeter wherein the sharp edge allows the edger blade 10 to cut vegetation effectively. FIG. 3 shows a user using the device as a weed trimmer so that edger blade 10 and trimmer line 12 are horizontal to the ground and, therefore, cut grass and weeds horizontal to the ground.

At least one trimmer line 12 is positioned within trimmer bar 16. Trimmer line 12 is shown spaced so that three pieces of trimmer line 12 are positioned through trimmer bar 16 so that trimmer line 12 is maintained in three rows of trimmer line stacked upon each other wherein each trimmer line 12 is of equal length. Trimmer line 12 may extend beyond edger bar 10, as shown, or, alternatively, not extend beyond edger blade 10. In the upright position, the attachment device trims grass and weeds more effectively than a standard trimmer because there are multiple layers of trimmer line 12 positioned about trimmer bar 16, and because edger blade 10 rotates about relative to trimmer head 6 cutting heavy vegetation. Edger blade 10 may be capable of cutting large diameter brush that a gas trimmer would not ordinarily be able to cut.

FIG. 4 shows the attachment device parallel to the ground so that edger blade 10 edges. In this embodiment, edger blade 10 may be a length of 10 inches, or another length, such as 8 inches in length so long as edger blade 10 is of a length less than the length of trimmer line 12. Trimmer line 12 may be 16 inches in length, or any length up to ˜24 inches in length so long as trimmer line 12 is longer than edger blade 10. The gas or electric weed trimmer may be angled so that only edger blade 10 edges when the trimmer head 6 is approximately 90 degrees to the ground. In this position, edger blade 10 effectively edges around garden beds, turf, etc. The attachment device may be manipulated so that trimmer line 12 is less than 90 degrees from the ground allowing trimmer lines 12 to edge instead of edger blade 10. Instead, all trimmer lines 12 may be removed from trimmer bar 16 allowing the user to edge with edger blade 10 at angles less than 90 degrees relative to the ground. This device allows a user to edge without adding wheels to the gas or electric weed trimmer

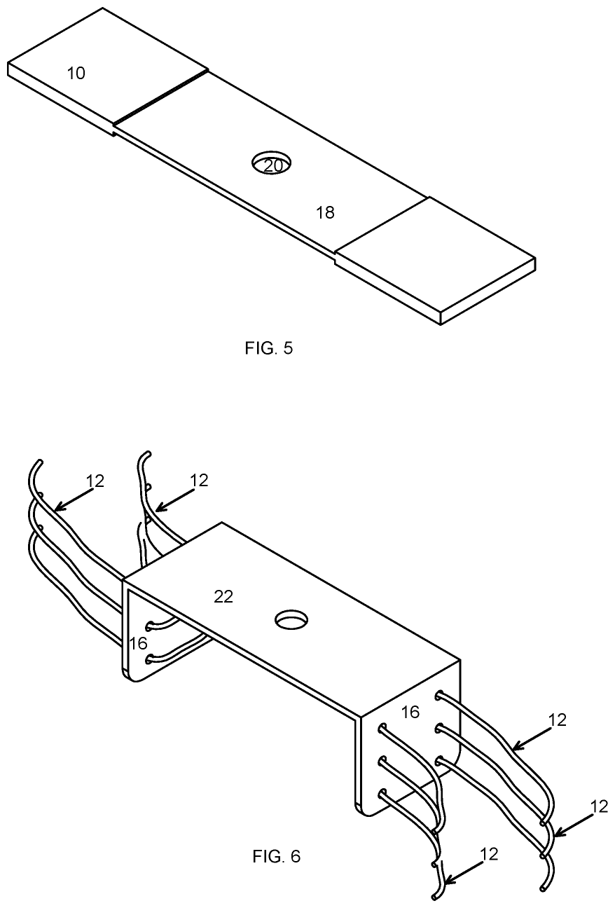

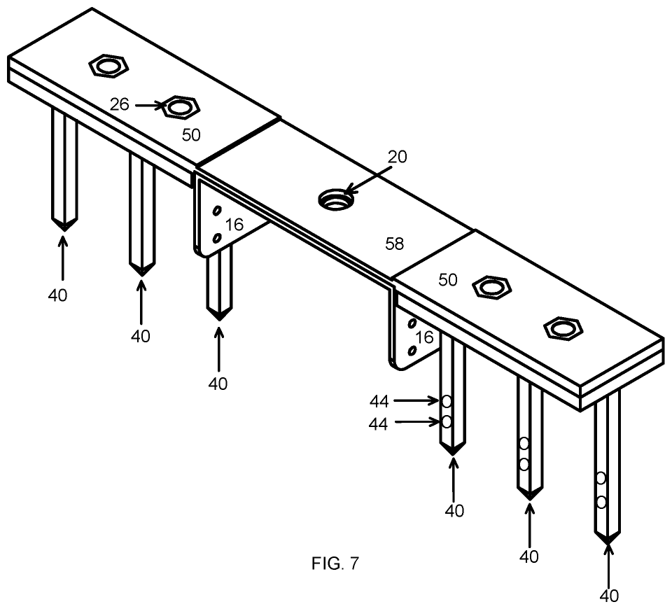

FIG. 5 depicts edger blade 10, which includes mounting plate 18 that rests against trimmer head 6 and opening 20, which may be utilized to attach edger blade 10 to trimmer head 6. The trimmer means is shown in FIG. 6. Trimmer bar plate 22 is coupled against mounting plate 18 while attached to a standard trimmer Trimmer bars 16 are formed onto trimmer bar plate 22. Multiple trimmer lines 12 are shown positioned within trimmer bars 16. Nail head trimmer line may be utilized. Notice that trimmer line 12 is positioned in three horizontal rows of 2 lines in each trimmer bar 16.

Edger blade 10 may be, for example, 10 inches in length, while trimmer line 12 is 16 inches in length, and trimmer bar plate 22 has a length of 2 inches, for a total of 18 inches. A user using the device parallel to the ground could cut a swath of 18 inches, including cutting large diameter weeds that are within the 10 inch length of edger blade 10. The combination of edger bar 10 and the trimmer line 12 configuration enable a user to cut a much larger swath of weeds and grass than a standard gas or electric weed trimmer

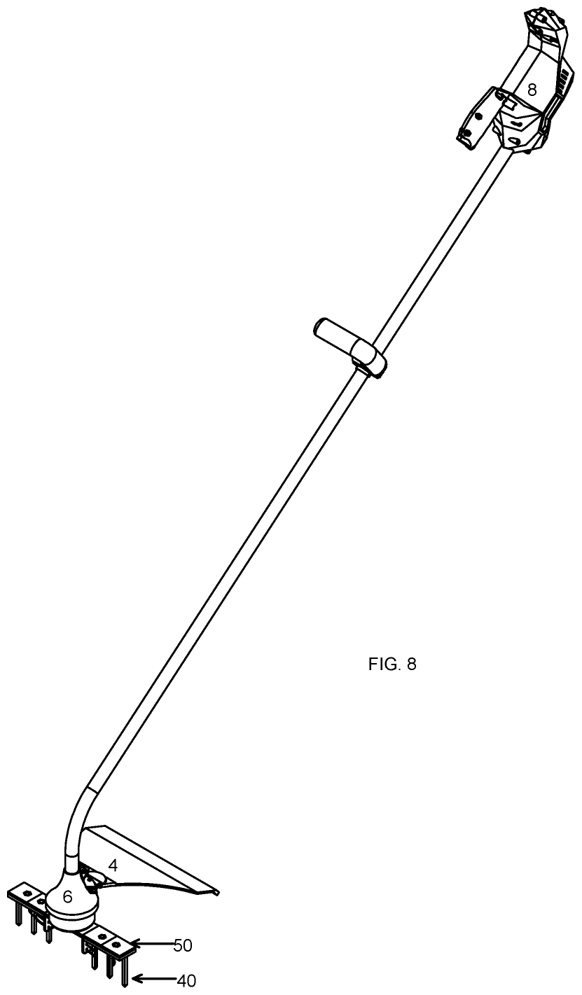

A rake head attachment device is shown in FIGS. 7 and 8. The rake head attachment device may be reversibly coupled to a standard commercially-available gas or electric trimmer The power from motor 8 of the trimmer powers the movement of the rake head in a circular direction relative to trimmer head 6. The movement of the rake head attachment device in a circular path allows the device to rake ground to de-thatch turf, till the top surface of ground, remove weeks from the surface layer of soil, etc. Opening 20 allows the device to be coupled to the gas trimmer Plates 58 and 55 form a structural base for attachment of teeth 40 via welds 26. Instead of welds, welds 26 may be nuts that teeth 40 are coupled to plate 50. Trimmer bar 16 may be coupled to plate 58 to stabilize the rake attachment device. Holes 44 may be included in teeth 40 to reduce weight and to allow water or soil to move through the rake attachment device to enhance the raking operation. Teeth 40 may be formed of metal, such as steel, aluminum, iron, etc. that is strong enough to allow the attachment device to move through soil.

I hereby claim:

1. A spooless line trimmer attachment for edging, trimming, shredding, and mulching vegetation that reversibly couples to a line trimmer, comprising:
a flat blade that reversibly couples to a head of the line trimmer,
wherein the flat blade includes a coupling means that couples the flat blade to the head of the line trimmer, wherein the flat blade includes a coupling means that couples the flat blade to a trimmer means, and
wherein the trimmer means comprises two bars coupled to each other by a flat bar, wherein each of the two bars includes at least six holes that reversibly couple a trimmer line to each of the two bars, wherein the six holes are spaced so that there are aligned in three horizontal rows of holes, wherein each horizontal row of holes includes at least two individual holes.

2. The device of claim 1 wherein the flat blade comprises at least one edge for edging, trimming, shredding, or mulching vegetation.

3. The device of claim 1 wherein the trimmer line trims vegetation.

4. A spooless line trimmer attachment for raking soil comprising:
a flat blade that reversibly couples to a head of the line trimmer, and
at least one or more teeth that couple to the flat blade, wherein the one or more teeth may be rotated in a circular motion by the line trimmer

5. The device of claim 4 wherein the flat blade is composed of metal.

6. The device of claim 4 wherein the one or more teeth are composed of metal.

7. The device of claim 4 wherein at least one of the one or more teeth has at least one hole.

8. The device of claim 1 wherein the flat blade is 10 inches in length.

9. The device of claim 1 wherein the trimmer line is 16 inches in length.

10. The device of claim 8 wherein the length of the trimmer line is greater than the length of the flat blade.
